(19) United States
(12) Patent Application Publication
(10) Pub. No.: US 2013/0205234 A1
(43) Pub. Date: Aug. 8, 2013

(54) MULTIMEDIA E-BOOK PRODUCING METHOD AND COMPUTER PROGRAM PRODUCT THEREOF

(71) Applicant: Jiunn-Sheng Yan, Taipei (TW)

(72) Inventor: Jiunn-Sheng Yan, Taipei (TW)

(21) Appl. No.: 13/366,681

(22) Filed: Feb. 6, 2012

(51) Int. Cl. G06F 3/01

(52) U.S. Cl. 715/762

(57) ABSTRACT

A multimedia e-book producing method, using a digital processing apparatus to produce a multimedia e-book, the method comprising the steps of: an identification step, used for retrieving a piece of identification information from an object for identifying the type of the object; a button zone creation step, used for creating a button zone for the object, executing a corresponding function generation procedure, and detecting the selection of the button zone; and a corresponding function execution step, used for executing a function specific to the object.

### BACKGROUND OF THE INVENTION

1. Field of the Invention

The present invention relates to a method for producing an e-book, especially to a multimedia e-book producing method, which can automatically create a button zone according to an object, and executing a function specific to the object when the button zone is selected.

2. Description of the Related Art

Prior art e-book production methods generally use a file conversion program to convert a document file or a paper book scanned file (being of .doc format or .jpg format or .ppt format) to an e-book file (being of PDF format or ePub format). However, an e-book produced in this manner can only exhibit static figures and text contents, and is dull somehow.

To enrich the content of an e-book, some prior art e-book production methods use a graphic design software (for example the Adobe Flash software) to produce multimedia e-books. However, as each added multimedia function has to be set up manually, the producing process will therefore consume much manpower and time, lacking efficiency.

To solve the foregoing problems, a novel multimedia e-book producing method, which can automatically create a button zone for an object to save editing time, is therefore needed.

### SUMMARY OF THE INVENTION

One objective of the present invention is to disclose a multimedia e-book producing method, which can use a digital processing apparatus to automatically create a button zone according to an object fed into a page, wherein, the button zone is used to execute a function specific to the object when the button zone is selected by a reader.

Still another objective of the present invention is to disclose a multimedia e-book producing method, which can use a digital processing apparatus to automatically create a button zone according to a new size and new location of an object after the object has gone through an editing operation of size adjustment, shifting, rotating, edge cutting, or any combination thereof, wherein, the button zone is used to execute a function specific to the object when the button zone is selected by a reader.

To attain the foregoing objectives, a multimedia e-book producing method, using a digital processing apparatus, is proposed, the method including the steps of:

an identification step, used for retrieving a piece of identification information from an object for identifying the type of the object;

a button zone creation step, used for creating a button zone for the object, executing a corresponding function generation procedure, and detecting the selection of the button zone; and

a corresponding function execution step, used for executing a function specific to the object.

The digital processing apparatus has a central processing unit.

Preferably, the digital processing apparatus has an operation system, which can be WINDOWS, UNIX, LINUX, MacOS, iOS, or Android.

The identification information can be a filename extension, a header, an access route, or a flag, wherein the flag is generated by using the filename extension or the header to select an object type from an object type group, or generated according to a selected one of a plurality of object type fed-in options displayed on a page before the object is fed into the digital processing apparatus.

The object type is one selected from a group consisting of figure type, text type, audio type, video type, Flash file type, website hyperlink, and a combination thereof.

The function specific to the object is one selected from a group consisting of playing a film, playing a Flash file, displaying an enlarged version of a picture, displaying slides, connecting to a website, and a combination thereof.

To attain the foregoing objectives, the present invention further proposes a computer program product, having a computer program, which can be loaded in and executed by a digital processing apparatus to implement the foregoing method.

To attain the foregoing objectives, the present invention further proposes another computer program product, having a computer program, which can be loaded in and executed by a digital processing apparatus to implement a multimedia e-book producing method, the method including the steps of:

an object identification information storing step, used for storing a piece of identification information of an object;

a button zone creation step, used for creating a button zone for the object and detecting the selection of the button zone; and

a corresponding function generation and execution step, used for executing a corresponding function generation procedure and executing a function specific to the object.

The digital processing apparatus has a central processing unit.

Preferably, the digital processing apparatus has an operation system, which can be WINDOWS, UNIX, LINUX, MacOS, iOS, or Android.

The piece of identification information can be a filename extension, a header, an access route information, or a flag. The flag can be generated by using the filename extension or the header to select an object type from an object type group, or generated according to a selected one of a plurality of object type fed-in options displayed on a page before the object is fed into the digital processing apparatus.

The object type is one selected from a group consisting of figure type, text type, audio type, video type, Flash file type, website hyperlink, and a combination thereof.

The function specific to the object is one selected from a group consisting of playing a film, playing a Flash file, displaying an enlarged version of a picture, displaying slides, connecting to a website, and a combination thereof.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates the flowchart of a multimedia e-book producing method according to a preferred embodiment of the present invention.

FIG. 2 illustrates the flowchart of a multimedia e-book producing method according to another preferred embodiment of the present invention.

FIG. 3(a) illustrates a plurality of object type fed-in options for loading an object into a digital processing apparatus.

FIG. 3(b) indicates that the present invention's multimedia e-book producing method creates button zones for object A, object B, object C, object D, and object E respectively, wherein object A, object B, object C, object D, and object E have gone through editing operations of size adjustment, shifting, rotating, and edge cutting.

FIG. 3(c) indicates that the present invention's multimedia e-book producing method executes a function specific to object A after object A is selected.

FIG. 4 illustrates the block diagram of function units formed in a digital processing apparatus for implementing the multimedia e-book producing method as illustrated in FIG. 1, after a computer program of a computer program product of the present invention is fed into and executed by the digital processing apparatus.

FIG. 5 illustrates the block diagram of function units formed in a digital processing apparatus for implementing the multimedia e-book producing method as illustrated in FIG. 2, after a computer program of a computer program product of the present invention is fed into and executed by the digital processing apparatus.

### DETAILED DESCRIPTION OF THE PREFERRED EMBODIMENTS

The present invention will be described in more detail hereinafter with reference to the accompanying drawings that show the preferred embodiments of the invention.

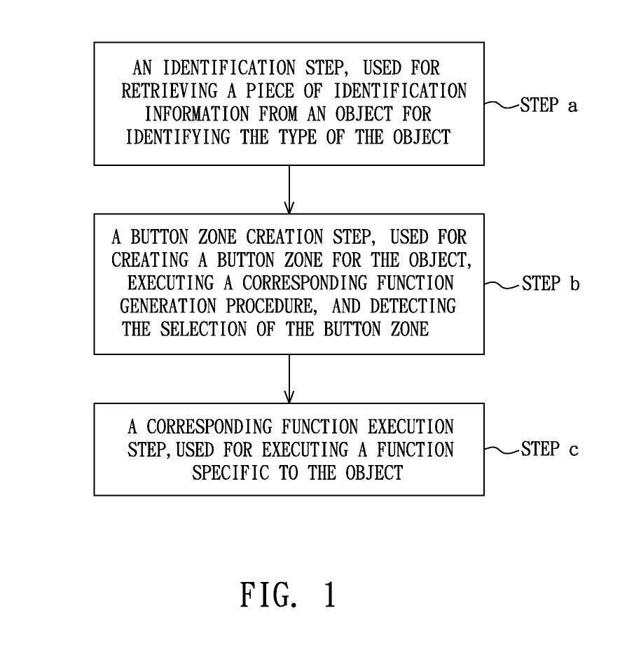

Please refer to FIG. 1, which illustrates the flowchart of a multimedia e-book producing method according to a preferred embodiment of the present invention. As illustrated in FIG. 1, the method includes the steps of: an identification step, used for retrieving a piece of identification information from an object for identifying the type of the object (step a); a button zone creation step, used for creating a button zone for the object, executing a corresponding function generation procedure, and detecting the selection of the button zone (step b); and a corresponding function execution step, used for executing a function specific to the object (step c).

In step a, the present invention's method uses a digital processing apparatus to execute an identification procedure for retrieving a piece of identification information from an object for identifying the type of the object, which can be figure type, text type, audio type, video type, Flash file type, website hyperlink, or any combination thereof. One embodiment of the identification procedure includes the step of: retrieving a piece of identification information from a corresponding object, which can be a filename extension, or a header, or an access route.

Another embodiment of the identification procedure includes the step of: generating a piece of identification information—for example, a flag—corresponding to the object type when the object is fed in the digital processing apparatus. The flag can be generated by using the filename extension or the header to select an object type from an object type group, or generated according to a selected one of a plurality of object type fed-in options displayed on a page before the object is fed into the digital processing apparatus. The object type group includes the elements of figure type, text type, audio type, video type, Flash file type, website hyperlink, and any combination thereof. The plurality of object type fed-in options includes figure fed-in option, video fed-in option, text fed-in option, audio fed-in option, Flash file fed-in option, and any combination thereof.

In step b, the present invention's method uses the digital processing apparatus to execute a button zone creation procedure to create a button zone according to the location of the object on a page—for example, creating the button zone for the object according to the size, coordinates, and angle of the object displayed on the page; execute a corresponding function generation procedure; and detect the selection of the button zone.

One embodiment of the corresponding function generation procedure is to let the identification information pass through a conditional statement structure, so as to choose one from a plurality of object functions as a corresponding object function. Another embodiment of the corresponding function generation procedure is to map the identification information onto an object corresponding function lookup table—can be stored in a program memory, a hard disk device, or a solid state storage device, so as to choose one from a plurality of object functions as a corresponding object function.

In step c, the present invention's method uses the digital processing apparatus to execute the corresponding object function—like playing a film, playing a Flash file, displaying an enlarged version of a picture, or displaying slides on a screen, or connecting to a website via internet, or any combination thereof—after the selection of the button zone is detected.

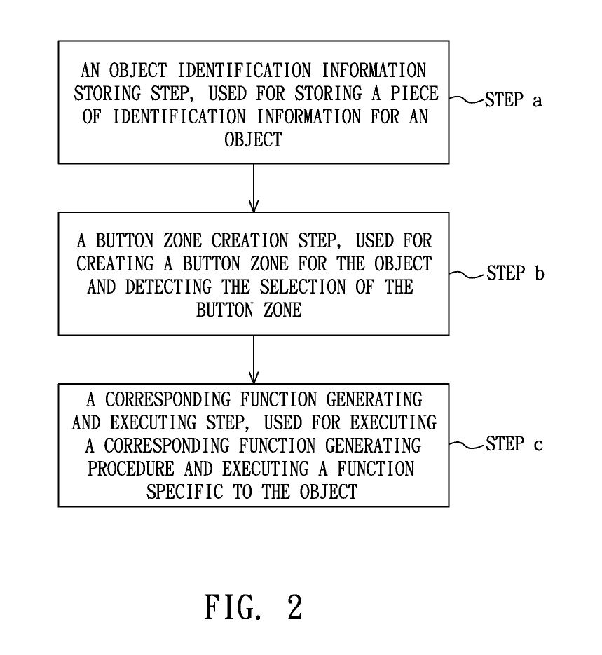

Based on the foregoing specification, the present invention further proposes another multimedia e-book producing method. Please refer to FIG. 2, which illustrates the flowchart of a multimedia e-book producing method according to another preferred embodiment of the present invention. As illustrated in FIG. 2, the method includes the steps of: an object identification information storing step, used for storing a piece of identification information for an object (step a); a button zone creation step, used for creating a button zone for the object and detecting the selection of the button zone (step b); and a corresponding function generating and executing step, used for executing a corresponding function generating procedure and executing a function specific to the object (step c).

In step a, the present invention's method uses a digital processing apparatus to execute an object identification information storing procedure to store a piece of identification information for an object when the object is fed into the digital processing apparatus. One embodiment of the object identification information storing procedure includes the step of: retrieving and storing a piece of identification information—can be a filename extension, or a header, or an access route—from a corresponding file of an object when the object is fed into the digital processing apparatus.

Another embodiment of the object identification information storing procedure includes the step of: generating and storing a piece of identification information—for example, a flag—corresponding to the type of an object when the object is fed into the digital processing apparatus. The flag can be generated by using the filename extension or the header to select an object type from an object type group, or generated according to a selected one of a plurality of object type fed-in options displayed on a page before the object is fed into the digital processing apparatus. The object type group includes the elements of figure type, text type, audio type, video type, Flash file type, website hyperlink, and any combination thereof. The plurality of object type fed-in options includes figure fed-in option, video fed-in option, text fed-in option, audio fed-in option, Flash file fed-in option, and any combination thereof.

In step b, the present invention's method uses the digital processing apparatus to execute a button zone creation procedure to create a button zone according to the location of the object on a page—for example, creating the button zone for the object according to the size, coordinates, and angle of the object displayed on the page; and detect the selection of the button zone.

In step c, the present invention's method uses the digital processing apparatus to execute a corresponding function generating procedure so as to generate and then execute a function specific to the object according to the identification information. One embodiment of the corresponding function generating procedure is to let the identification information pass through a conditional statement structure, so as to choose one from a plurality of object functions as a corresponding object function, and then execute the corresponding object function. Another embodiment of the corresponding function generating procedure is to map the identification information onto an object corresponding function lookup table—can be stored in a program memory, a hard disk device, or a solid state storage device, so as to choose one from a plurality of object functions as a corresponding object function, and then execute the corresponding object function. The corresponding object function can be playing a film, playing a Flash file, displaying an enlarged version of a picture, or displaying slides on a screen, or connecting to a website via internet, or any combination thereof.

Preferably, the detection of the selection of the button zone is performed by detecting the input operation of a mouse, a keyboard, or a touch screen.

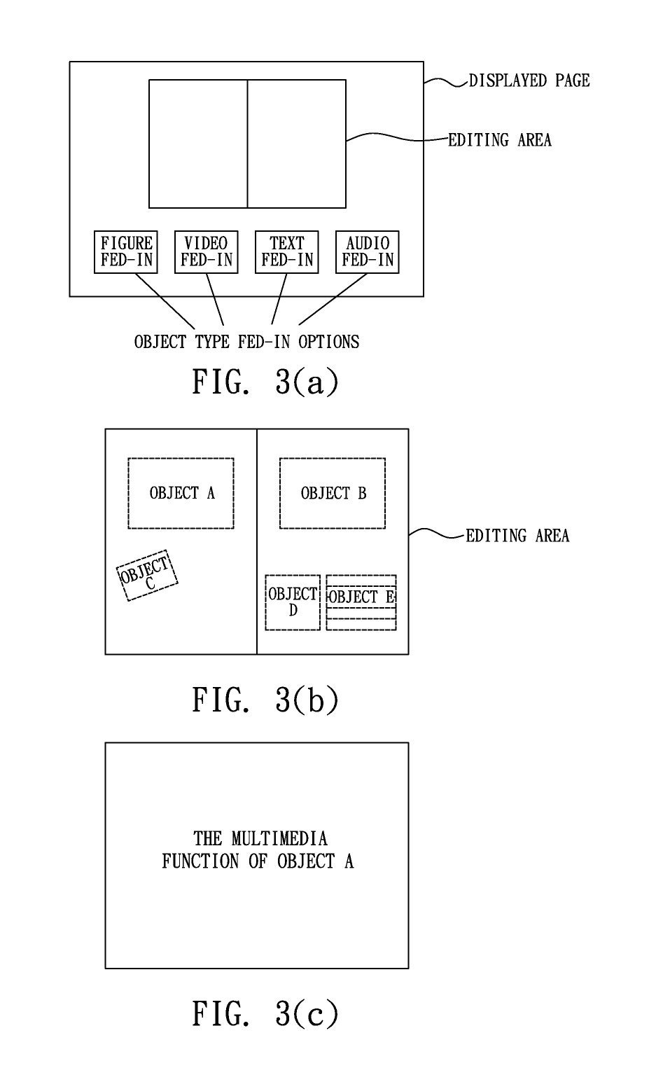

Please refer to FIGS. 3(a), 3(b), and 3(c), which illustrate an operation example of the present invention. FIG. 3(a) illustrates a plurality of object type fed-in options for loading an object into a digital processing apparatus. FIG. 3(b) indicates that the present invention's multimedia e-book producing method generates button zones for object A, object B, object C, object D, and object E, wherein object A, object B, object C, object D, and object E have gone through editing operations of size adjustment, shifting, rotating, and edge cutting. FIG. 3(c) indicates that the present invention's multimedia e-book producing method executes a function specific to object A—playing film A, for example—after object A is selected.

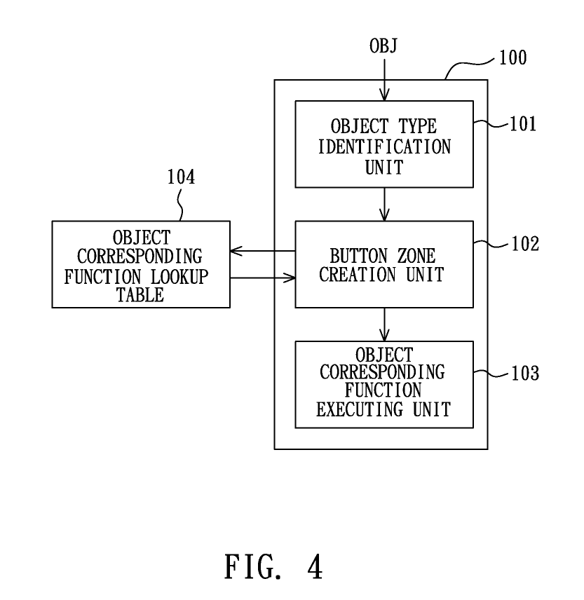

Based on the foregoing specification, the present invention proposes a computer program product, having a computer program, which, when loaded into and executed by a digital processing apparatus, can implement the multimedia e-book producing method as illustrated in FIG. 1 or FIG. 2. Please refer to FIG. 4, which illustrates the block diagram of function units formed in a digital processing apparatus 100 for implementing the multimedia e-book producing method as illustrated in FIG. 1, after a computer program of a computer program product of the present invention is fed into and executed by the digital processing apparatus 100. As illustrated in FIG. 4, the function units formed in the digital processing apparatus 100 include an object type identification unit 101, a button zone creation unit 102, and an object corresponding function executing unit 103.

The object type identification unit 101 is used for executing an identification procedure for retrieving a piece of identification information from an object for identifying the type of the object, which can be figure type, text type, audio type, video type, Flash file type, website hyperlink, or any combination thereof. One embodiment of the identification procedure includes the step of: retrieving a piece of identification information—can be a filename extension, or a header, or an access route—from a corresponding file of the object when the object is fed into the digital processing apparatus 100.

Another embodiment of the identification procedure includes the step of: generating a piece of identification information—for example, a flag—corresponding to the type of the object when the object is fed into the digital processing apparatus 100. The flag can be generated by using the filename extension or the header to select an object type from an object type group, or generated according to a selected one of a plurality of object type fed-in options displayed on a page before the object is fed into the digital processing apparatus. The object type group includes the elements of figure type, text type, audio type, video type, Flash file type, website hyperlink, and any combination thereof. The plurality of object type fed-in options includes figure fed-in option, video fed-in option, text fed-in option, audio fed-in option, Flash file fed-in option, and any combination thereof.

The button zone creation unit 102 is used to execute a button zone creation procedure to set up a button zone according to the location of the object on a page—for example, creating the button zone for the object according to the size, coordinates, and angle of the object displayed on the page; execute a corresponding function generation procedure; and detect the selection of the button zone.

One embodiment of the corresponding function generation procedure is to let the identification information pass through a conditional statement structure, so as to choose one from a plurality of object functions as a corresponding object function. Another embodiment of the corresponding function generation procedure is to map the identification information onto an object corresponding function lookup table 104—can be stored in a program memory, a hard disk device, or a solid state storage device, so as to choose one from a plurality of object functions as a corresponding object function.

The object corresponding function execution unit 103 is used to execute the corresponding object function—like playing a film, playing a Flash file, displaying an enlarged version of a picture, or displaying slides on a screen, or connecting to a website via internet, or any combination thereof—after the selection of the button zone is detected.

The object corresponding function look-up table 104 stores the information of a plurality of (identification information, corresponding function).

Preferably, the object corresponding function look-up table 104 is located in a program memory, a hard disk device, or a solid state storage device.

Preferably, the digital processing apparatus 100 has a central processing unit.

Preferably, the digital processing apparatus 100 has an operation system, which can be WINDOWS, UNIX, LINUX, MacOS, iOS, or Android.

Preferably, the digital processing apparatus 100 has a display, which can be a CRT display, a liquid crystal display, a plasma display, or an e-paper display.

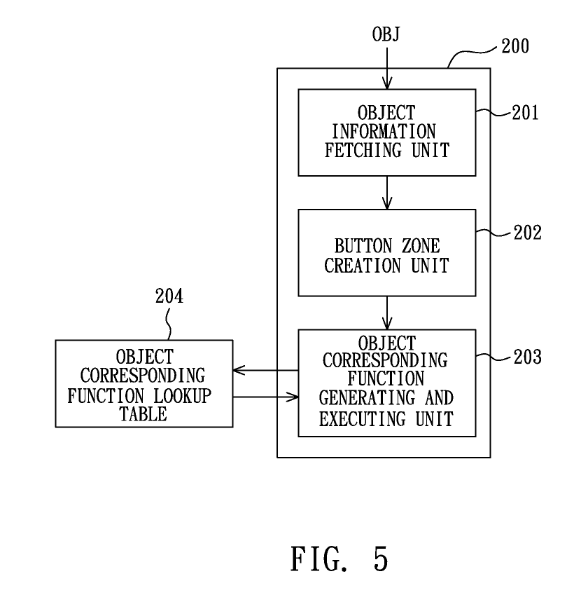

Please refer to FIG. 5, which illustrates the block diagram of function units formed in a digital processing apparatus 200 for implementing the multimedia e-book producing method as illustrated in FIG. 2, after a computer program of a computer program product of the present invention is fed into and executed by the digital processing apparatus 200. As illustrated in FIG. 5, the function units formed in the digital processing apparatus 200 include an object information fetching unit 201, a button zone creation unit 202, and an object corresponding function generating and executing unit 203.

The object information fetching unit 201 is used to execute an object identification information storing procedure to store a piece of identification information for an object when the object is fed into the digital processing apparatus 200. The identification information can be a filename extension, or a header, or an access route, or a flag. The flag can be generated by using the filename extension or the header to select an object type from an object type group, or generated according to a selected one of a plurality of object type fed-in options displayed on a page before the object is fed into the digital processing apparatus 200. The object type group includes the elements of figure type, text type, audio type, video type, Flash file type, website hyperlink, and any combination thereof. The plurality of object type fed-in options includes figure fed-in option, video fed-in option, text fed-in option, audio fed-in option, Flash file fed-in option, and any combination thereof.

The button zone creation unit 202 is used to execute a button zone creation procedure to create a button zone according to the location of the object on a page—for example, creating the button zone for the object according to the size, coordinates, and angle of the object displayed on the page; and detect the selection of the button zone.

The object corresponding function generating and executing unit 203 is used to execute a corresponding function generating procedure so as to generate and then execute a function specific to the object according to the identification information. One embodiment of the corresponding function generating procedure is to let the identification information pass through a conditional statement structure, so as to choose one from a plurality of object functions as a corresponding object function, and then execute the corresponding object function. Another embodiment of the corresponding function generating procedure is to map the identification information onto an object corresponding function lookup table 204—can be stored in a program memory, a hard disk device, or a solid state storage device, so as to choose one from a plurality of object functions as a corresponding object function, and then execute the corresponding object function. The corresponding object function can be playing a film, playing a Flash file, displaying an enlarged version of a picture, or displaying slides on a screen, or connecting to a website via internet, or any combination thereof.

The object corresponding function look-up table 205 stores the information of a plurality of (identification information, corresponding function).

Preferably, the object corresponding function look-up table 205 is located in a program memory, a hard disk device, or a solid state storage device.

Preferably, the digital processing apparatus 200 has a central processing unit.

Preferably, the digital processing apparatus 200 has an operation system, which can be WINDOWS, UNIX, LINUX, MacOS, iOS, or Android.

Preferably, the digital processing apparatus 200 has a display, which can be a CRT display, a liquid crystal display, a plasma display, or an e-paper display.

The present invention has the following advantages due to its novel design:

1. The present invention can automatically create a button zone for an object according to the type of the object, and therefore is capable of providing a friendly e-book editing interface to save manpower and time.

2. The present invention can automatically set up a button zone for an object according to the type of the object after the object is edited by an operation of size adjustment, shifting, rotating, edge cutting, or any combination thereof, and therefore is capable of providing a friendly e-book editing interface to save manpower and time.

3. The present invention can offer a multimedia function connection for each object exhibited on a page of an e-book, and therefore is capable of enriching the content of the e-book. For example, it can display a figure/photo file in a slide show manner, or activate a medium player to play a film file or a music file.

4. The digital processing apparatus of the present invention can be implemented in a general operation system like WINDOWS, UNIX, LINUX, MacOS, iOS, or Android, making the present invention possess universality.

In conclusion, the present invention's multimedia e-book producing method can automatically set up a button zone for an object according to the type of the object, so as to provide a friendly e-book editing interface. Besides, the present invention can make each object on a page of an e-book possess a multimedia function connection, so as to enrich the content of the e-book. What's more, the present invention can automatically create a button zone according to the type of an object after the object has gone through an editing operation of size adjustment, shifting, rotating, edge cutting, or any combination thereof, and is therefore capable of saving manpower and time. The present invention thus possesses superior advantages.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A multimedia e-book producing method, using a digital processing apparatus to produce a multimedia e-book, the method comprising the steps of:
an identification step, used for retrieving a piece of identification information from an object for identifying the type of the object;
a button zone creation step, used for creating a button zone for said object, executing a corresponding function generation procedure, and detecting the selection of said button zone; and
a corresponding function execution step, used for executing a function specific to said object.

2. The multimedia e-book producing method as disclosed in claim 1, wherein said digital processing apparatus has a central processing unit.

3. The multimedia e-book producing method as disclosed in claim 1, wherein said digital processing apparatus has an operation system, which is WINDOWS, UNIX, LINUX, MacOS, iOS, or Android.

4. The multimedia e-book producing method as claim 1, wherein said identification information is a filename extension, a header, an access route, or a flag, said flag being generated by using said filename extension or said header to select an object type from an object type group, or generated according to a selected one of a plurality of object type fed-in options displayed on a page before said object is fed into said digital processing apparatus.

5. The multimedia e-book producing method as claim 1, wherein said object type is one selected from a group consisting of figure type, text type, audio type, video type, Flash file type, website hyperlink type, and a combination thereof.

6. The multimedia e-book producing method as claim 1, wherein said function specific to said object is one selected from a group consisting of playing a film, playing a Flash file, displaying an enlarged version of a picture, displaying slides, connecting to a website, and a combination thereof.

7. A computer program product, having a computer program, which can be loaded in and executed by a digital processing apparatus to implement the method as disclosed in claim 1.

8. A computer program product, having a computer program, which can be loaded in and executed by a digital processing apparatus to implement a multimedia e-book producing method, the method including the steps of:
an object identification information storing step, used for storing an identification data of an object;
a button zone creation step, used for creating a button zone for said object and detecting the selection of said button zone; and
a corresponding function generating and executing step, used for executing a corresponding function generating procedure and executing a function specific to said object.

9. The computer program product as disclosed in claim 8, wherein said digital processing apparatus has a central processing unit.

10. The computer program product as disclosed in claim 8, wherein said digital processing apparatus has an operation system, which is WINDOWS, UNIX, LINUX, MacOS, iOS, or Android.

11. The computer program product as disclosed in claim 8, wherein said identification information is a filename extension, a header, an access route, or a flag, said flag being generated by using said filename extension or said header to select an object type from an object type group, or generated according to a selected one of a plurality of object type fed-in options displayed on a page before said object is fed into said digital processing apparatus.

12. The computer program product as disclosed in claim 8, wherein said object type is one selected from a group consisting of figure type, text type, audio type, video type, Flash file type, website hyperlink, and a combination thereof.

13. The computer program product as disclosed in claim 8, wherein said function specific to said object is one selected from a group consisting of playing a film, playing a Flash file, displaying an enlarged version of a picture, displaying slides, connecting to a website, and a combination thereof.
